(19) United States
(12) Patent Application Publication
(10) Pub. No.: US 2005/0144299 A1
(43) Pub. Date: Jun. 30, 2005

(54) System and method for supporting XA 2-phase commit protocols with a loosely coupled clustered database server

(76) Inventors: Delmar Eugene Blevins, Los Gatos, CA (US); Curt Lee Cotner, Gilroy, CA (US); Stephen Joseph Kinder, Hyde Park, NY (US); James Willis Pickel, Gilroy, CA (US); Matthew James Sykes, Poughkeepsie, NY (US); Hong S. Tie, San Jose, CA (US)

Correspondence Address: LACASSE & ASSOCIATES, LLC, 1725 DUKE STREET, SUITE 650, ALEXANDRIA, VA, 22314, US

(21) Appl. No.: 10/726,702

(22) Filed: Dec. 4, 2003

(51) Int. Cl. G06F 15/16

(52) U.S. Cl. 709/230

(57) ABSTRACT

Indoubt transaction entries are recorded for each member of a database cluster, thereby avoiding the CPU cost and elapsed-time impact of persisting this information to a disk (either via a log write or a relational table I/O). This implementation allows for full read/write access and data coherency for concurrent access by all the members in the database cluster. At any given point in time, a full list of indoubt transactions is maintained for the entire database cluster in a relational table (e.g., an SQL table).

### BACKGROUND OF THE INVENTION

1. Field of Invention

The present invention relates generally to the field of software such as middleware. More specifically, the present invention is related to software or middleware implementing robust 2-phase commit protocols.

2. Discussion of Prior Art

The Open Group's XA protocol has become a computer industry standard for performing 2-phase commit operations between transaction managers and resource managers. FIG. 1 illustrates a functional relationship between transaction manager (e.g., WebSphere®, WebLogic®, etc.) 102 and resource manager (e.g., DB2®, Oracle®, SQL Server, etc.) 104 on the Unix® and Microsoft Windows® platforms. Resource manager (RM) 104 is responsible for managing a part of a computer's shared resources (i.e., software entities can request access to a resource from time to time, using services that the RM provides), while transaction manager 102 is responsible for managing global transactions, coordinating the decision to commit them or roll them back, and coordinating failure recovery.

Transaction manager 102 and resource manager 104 use a 2-phase commit with presumed rollback. In a first phase, transaction manager 102 asks resource manager 104 to prepare to commit transaction branches (i.e., resource manager 104 is queried to see if it can guarantee the ability to commit a transaction branch). If resource manager 104 is able to commit, it records any pertinent information it needs to do so, then replies affirmatively. A negative reply indicates failure of a transaction. After making a negative reply and rolling back its work, resource manager 104 can discard any knowledge it has of the transaction branch.

In a second phase, transaction manager 102 issues resource manager 104 an actual request to commit or roll back the transaction branch. Prior to issuing requests to commit, transaction manager 102 records decisions to commit, as well as a list of all involved resource managers (in this case, resource manager 104). Resource manager 104 either commits or rolls back changes to resources and then returns status to the transaction manager 102. Transaction manager 102 can then delete entries related to the global transaction.

Although XA is an industry standard, it is not nearly as robust as some of the proprietary 2-phase commit protocols that have been developed on other platforms such as OS/390 (e.g., IBM's systems network architecture (SNA) 2-phase commit used by Information Management Service (IMS) and IBM's customer information control system (CICS), resource recovery services (RRS) 2-phase commit used by WebSphere and DB2, and distribution relational database architecture (DRDA) 2-phase commit used by the DB2 family of products).

Provided below, and as depicted in FIG. 2, the following examples illustrate some of the scenarios where the XA protocol is less robust than some of the proprietary 2-phase commit protocols:
XA requires that transaction manager 102 drive the XA RECOVER algorithm 206 to resolve indoubt units of work. Transaction manager 102 calls XA_RECOVER( ) algorithm during recovery to obtain a list of transaction branches that are currently in a prepared or heuristically completed state. It should be noted that there is no provision for resource manager 104 to initiate the resolution of an indoubt unit of work.
XA RECOVER 206 requires that resource manager 104 provide a full list of indoubt transactions, but it has no provision where the members of a database server cluster can resolve indoubt units of work individually with the transaction manager 102. FIG. 3 specifically illustrates this scenario, wherein a full list of indoubt transactions 302 are passed on to XA RECOVER algorithm 303, but a member 304 of a database server cluster is unable to resolve individual indoubt units of work 306, 308, and 310 with transaction manager 102.
Indoubt units of work are typically resolved in XA during transaction manager 102 restart, as there's very little support for automatically resolving an indoubt unit of work that occurs due to a communication failure on a single network connection (i.e., only 1 of the “n” communication connections failed), without restarting the transaction manager 102.

The DB2 for OS/390 and z/OS product was designed to take advantage of these more robust 2-phase commit capabilities. There are a number of middleware products on the market that have the need to map the XA protocols to the 2-phase commit protocols used in DRDA or RRS, so that they can provide XA Transaction Manager support for customers that want to use DB2 for OS/390 and z/OS as their database server. Examples of such products include Neon Shadow Direct from Neon Systems®, Java® drivers from DataDirect® (formerly known as Merant®), Java drivers from HiT Software®, Oracle Transparent Gateway®, and miscellaneous middleware offerings from Microsoft®.

The trend in the middleware market is to provide a thin client containing a 100% Java driver for Java Data Base Connectivity (JDBC) and Structured Query Language for Java (SQLJ) that has no client-side DLLs or log files. All of the above vendors struggle to provide a functionally incomplete thin client solution for XA support when the DB2 for OS/390 database is configured for parallel sysplex. Some of issues that make this difficult to implement are as follows:
DB2 does not support a DRDA message flow that provides the function required to implement XA RECOVER (i.e., a message response that provides the complete list of indoubt units of work threads in all the members of the parallel sysplex).
DB2 has independent logs for each member of the parallel sysplex, so there is no single repository that can be interrogated to determine the full list of indoubt units of work for the entire cluster of database server members.
The DB2 parallel sysplex can be fully operational with only a subset of the DB2 members active, making it very possible that one or more members of the parallel sysplex are not available when the XA transaction manager issues the XA RECOVER request.

The following references provide for a general teaching in the area of distributed computing and database configuration.

The Slaughter et al. U.S. Pat. No. (6,014,669), assigned to Sun Microsystems, provides for a highly-available distributed cluster configuration database. The cluster configuration database is a distributed configuration database wherein a consistent copy of the configuration database is maintained on each active node of the cluster. Each node in the cluster maintains its own copy of the configuration database and configuration database operations can be performed from any node. Configuration database updates are automatically propagated to each node in a lock-step manner. If any node experiences a failure, the configuration database uses a reconfiguration protocol to insure consistent data in each node of the cluster.

The Badovinatz et al. U.S. Pat. No. (5,805,786), assigned to International Business Machines, provides for the recovery of a name server managing membership of a domain of processors in a distributed computer environment which includes detecting the failure of the name server node and consulting a membership list of nodes in the domain to determine the crown prince (CP) node who is next in line to become the name server. The other available nodes in the domain periodically send recover messages to the CP node, and responsive to receiving the recover messages from all the other available nodes in the domain, the CP node perform a two phase takeover whereby the CP node becomes the name server for managing said processors in the domain. After the CP node becomes the name server, the other available nodes in the domain send data to the new name server necessary for the name server to manage the other available nodes in the domain. All request messages requesting management by the name server are stored locally until after the CP becomes the name server. The locally stored request messages are then processed by the other available nodes such that no request messages are lost during recovery. U.S. Pat. Nos. 5,896,503 and 5,790,788, also assigned to International Business Machines, provide for similar teachings.

The Attanasio et al. U.S. Pat. No. (5,668,943), assigned to International Business Machines, provides for a system and method for recovering from failures in the disk access path of a clustered computing system. Each node of the clustered computing system is provided with proxy software for handling physical disk access requests from applications executing on the node and for directing the disk access requests to an appropriate server to which the disk is physically attached. The proxy software on each node maintains state information for all pending requests originating from that node. In response to detection of a failure along the disk access path, the proxy software on all of the nodes directs all further requests for disk access to a secondary node physically attached to the same disk.

The patent publication to Jacobs et al. (2003/0018732) discloses a method for replicating data over a network using a one or two phase method. For the one phase method, a master server containing an original copy of the data sends a version number for the current state of the data to each slave on the network so that each slave can request a delta from the master. The delta that is requested contains the data necessary to update the slave to the appropriate version of the data. For the two phase method, the master server sends a packet of information to each slave. The packet of information can be committed by the slaves if each slave is able to process the commit. Patent publication 2003/0023898, also by Jacobs et al., provides for a similar teaching.

The Japanese patent to Brockmeyer et al., assigned to International Business Machines, discloses an expansion function of the two-phase commit protocol which attains the subscription of distributed subscribers between physically separated agents without relying upon the communication mechanism used in data processing systems.

The non-patent literature to Svobodova entitled, “File Servers for Network-Based Distributed Systems,” discloses a file server that provides remote centralized storage with options for performing an atomic update of data stored in the file server.

The non-patent literature to Mohan et al., entitled “Method for Distributed Transaction Commit and Recovery Using Byzantine Agreement Within Clusters of Processors,” replaces the second phase of one of the commit algorithms with a Byzantine agreement, allowing for certain trade-offs and advantages at the time of commit (thereby providing speed advantages at the time of recovery from failure).

The non-patent literature to Wang et al. entitled, “A Mobile Agent Based Protocol for Distributed Database Access,” provides for a three-tier protocol to improve data transmission while accessing distributed databases.

The non-patent literature to Hsial entitled, “DLFM: A Transactional Resource Manager,” provides for a two-phase commit protocol and a scheme for enabling rolling back a transaction update after a commit to the local database.

Chapter 14 of the book entitled “Advanced Database Systems” provides a review of parallel recovery in replicated databases.

Whatever the precise merits, features, and advantages of the above cited references, none of them achieve or fulfills the purposes of the present invention.

### SUMMARY OF THE INVENTION

The present invention provides a system and method for implementing support for the XA 2-phase commit protocols in client middleware for a cluster of one or more database servers that use shared disk technology. The present invention's method, as implemented in middleware, comprises the steps of: (a) aiding in receiving an invocation from a client for a first phase of commit for a transaction representing a unit of work; (b) inserting an entry in a relational table corresponding to the unit of work and transmitting an instruction to the server to prepare to commit for the transaction, wherein the inserted entry indicating the unit of work is potentially an indoubt entry; (c) receiving a request from the client, and
if the received request is a commit or rollback decision:
   communicating with a server and processing the commit or rollback request, and upon successful processing,
   deleting a corresponding entry in the relational table, else if the received request is a recover decision:
   querying the relational table to identify a list of indoubt units of work;
   transmitting the list of indoubt units of work to the client;
   receiving a commit or rollback decision from the client;
   communicating with the server to process the commit or rollback request, and upon successful processing, and
   deleting a corresponding entry in the relational table.

The present invention provides support for the XA 2-phase commit protocols without requiring the target database system to understand the XA 2-phase commit protocol. This is accomplished by mapping the XA 2-phase commit protocols onto other 2-phase commit protocols that the database server does support (such as the non-XA 2-phase commit protocols that are defined in DRDA). Furthermore, the system and method allow the client system to fully support the XA RECOVER command in the instance that one or more members in the database server cluster are unavailable.

The present invention eliminates the need to scan logs of all the database members to produce a list of indoubt units of work for the XA RECOVER command and also eliminates the need for client-side logging in the database middleware when the DB2 server does not support XA protocols natively. Based upon the teachings of the present invention, the XA transaction manager and database middleware are able to issue the XA RECOVER command from any computer in the network (with no dependency on issuing RECOVER from the same computer in the network or the same IP address in the network).

### BRIEF DESCRIPTION OF THE DRAWINGS

FIG. 1 illustrates a functional relationship between a transaction manager and a resource manager.

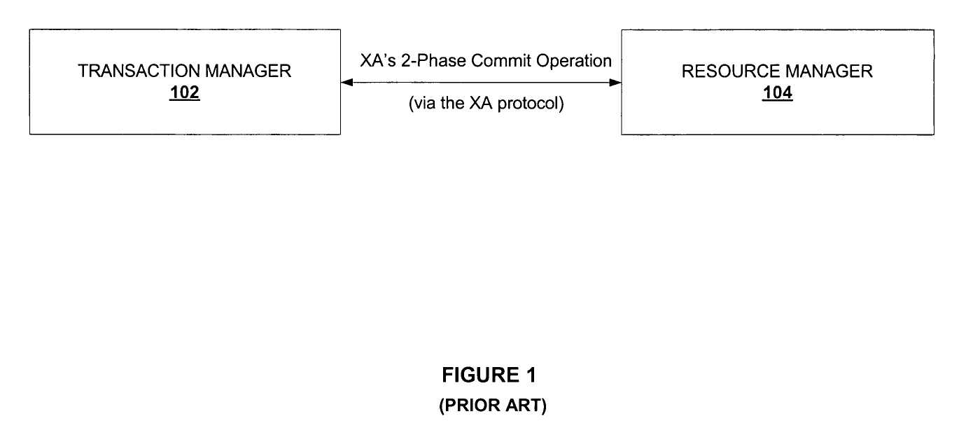

FIG. 2 illustrate a sample scenario where the XA protocol is less robust than other proprietary 2-phase commit protocols.

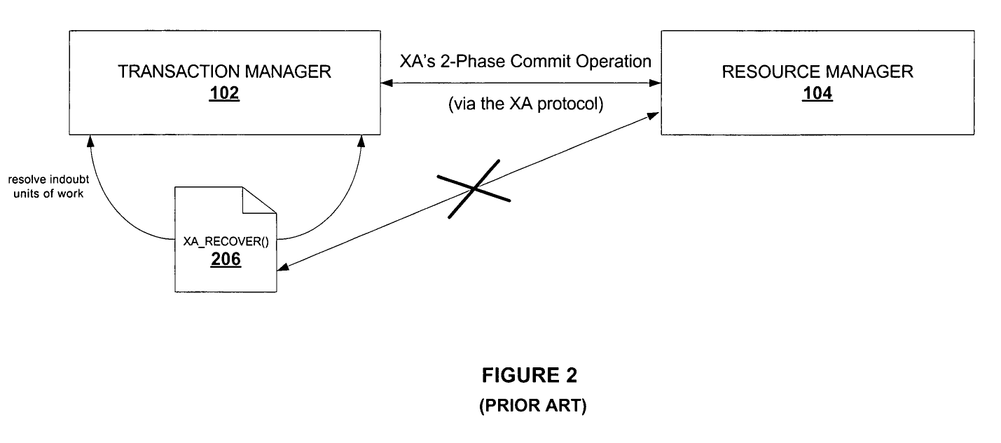

FIG. 3 illustrates a drawback of the XA protocol in its inability to address and resolve each individual indoubt transaction.

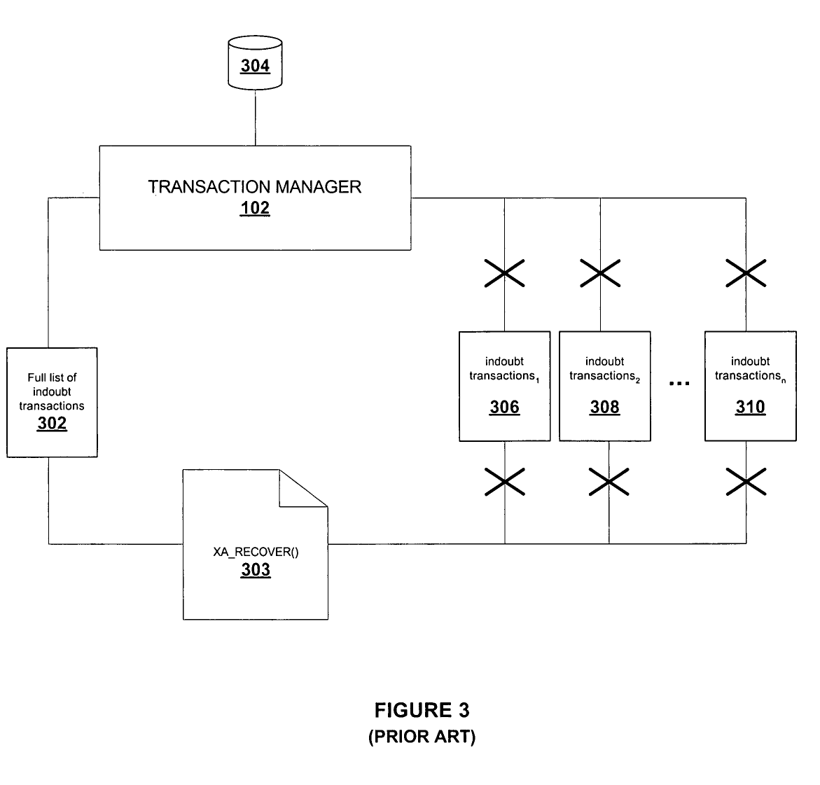

FIG. 4a illustrates one embodiment of the system of the present invention.

FIG. 4b illustrates a method associated with the embodiment of FIG. 4a.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

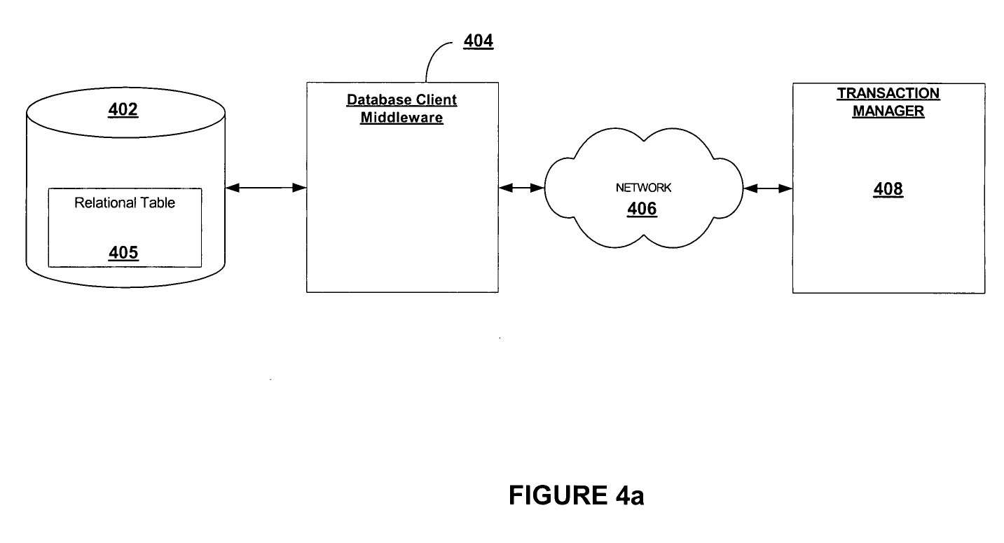

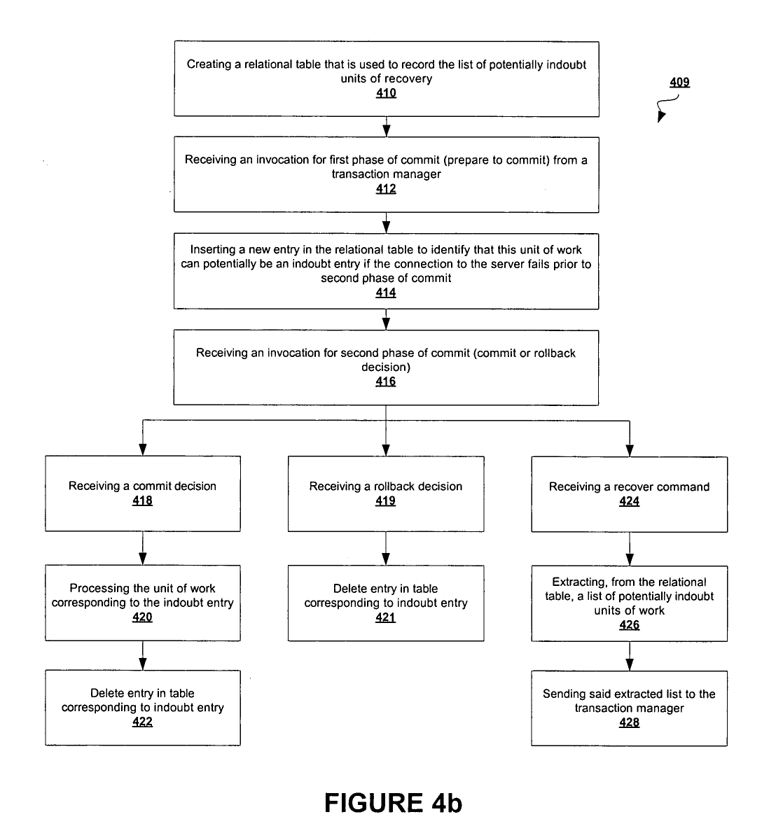

FIG. 4a illustrates a system based upon the present invention that supports the XA 2-phase commit protocol in a shared database. In this embodiment, a database client middleware 404 is used to record indoubt transaction entries in a relational table 405 for database 402. The transactional manager is able to communicate with database client middleware via network 408.

FIG. 4b illustrates a method 409 associated with the system of 4a. In step 410, during install of the database client middleware, the database client middleware creates a relational table that is used to record a list of potentially indoubt units of recovery. In one embodiment, the table specifies row-level locking, so that contention on the table is kept to a minimum.

For example:

```
CREATE TABLESPACE INDOUBT_TS LOCKSIZE(ROW);
CREATE TABLE SYSIBM.INDOUBT_LIST (
    XA_XID VARCHAR(128) FOR BIT DATA NOT NULL, /* the XA transaction ID */
    LUWID VARCHAR(32) FOR BIT DATA NOT NULL,  /* LUWID used by the DB2 server logging */
    STATE CHAR(1),  /* I=INDOUBT, C=HUERISTIC COMMIT, R=HUERISTIC ROLLBACK */
    INDOUBT_TIME TIMESTAMP, /* timestamp when first indoubt */
    UNIQUE(XA_XID))
IN INDOUBT_TS;
```

In step 412, the database client middleware receives an invocation from the XA transaction manager for the first phase of commit (prepare to commit) for a transaction that is not a read-only transaction. In step 414, the database client middleware issues an instruction, such as an SQL INSERT, to add a new row with STATE=‘I’ to the INDOUBT_LIST table to identify that this unit of work can potentially become indoubt if the connection to the DB2 server fails before the second phase of commit. In one embodiment, to minimize the cost of this INSERT operation, the client middleware can flow the INSERT request on the same network message that includes the prepare-to-commit message. It should be noted that no action is taken for read-only units of work, since by definition they do not become indoubt units of work.

In step 416, the database client middleware receives an invocation from the XA transaction manager for a second phase of commit for non-read-only transactions (commit or rollback decision). In step 418, the database client middleware waits for a reply message indicating that the server (e.g., DB2 server), as in step 420, has successfully processed the commit or rollback request. Once such an indication is received, in step 422, the database client middleware will queue a DELETE request specifying a predicate for the XA_XID value. This DELETE request is placed on a separate network connection, so that the DELETE does not start a new unit of work on the network connection that is used by the calling application. The processing is optimized by having one or more network connections that are always available for this purpose, and chaining the COMMIT for the DELETE operation on a single network message exchange. In the event a ROLLBACK decision is received as in step 419, the database client middleware implements the rollback decision and, in step 421, deletes the corresponding entry in the relational table.

In step 424, the XA RECOVER command is received from the XA transaction manager and, in step 426, the client middleware issues a query (e.g., SELECT XA_XID, LUWID FROM SYSIBM.INDOUBT_LIST WITH ISOLATION(UR)) for extracting a list containing indoubt entries. The rows returned by this query contain potentially indoubt units of work. In step 428, the rows returned by the above-mentioned query are sent to the XA transaction manager. In one embodiment, ISOLATION(UR) is used to guarantee that the query will read all the rows, even if locks are held on rows in the table due to indoubt units of work that are owned by other database connections.

When the XA transaction manager provides the commit or rollback decisions for the indoubt units of work that were identified by the XA RECOVER list, the database client middleware will flow the commit/rollback decision along with the LUWID value that was obtained from the XA RECOVER processing to the DB2 server to resolve the indoubt unit of work. When the database client middleware receives the confirmation message indicating the DB2 server has successfully resolved the indoubt unit of work (or confirmed that no such unit or work exists), the database client middleware will queue a DELETE request specifying a predicate for the XA_XID value that was resolved. This DELETE request must be placed on a separate network connection, since the DELETE request must be processed by the SQL engine (not the DB2 2-phase resynchronization process). The processing here can be optimized by having one or more network connections that are always available for this purpose, and chaining the COMMIT for the DELETE operation on a single network message exchange.

Furthermore, the present invention includes a computer program code based product, which is a storage medium having program code stored therein which can be used to instruct a computer to perform any of the methods associated with the present invention. The computer storage medium includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, and/or any other appropriate static or dynamic memory or data storage device.

Implemented in computer program code based products are software modules for: (a) aiding in receiving an invocation from the client for a first phase of commit for a transaction representing a unit of work; (b) inserting an entry in the relational table corresponding to the unit of work and transmitting an instruction to the server to prepare to commit for the transaction, wherein the inserted entry indicating the unit of work is potentially an indoubt entry; (c) receiving a request from the client, and
if the received request is a commit or rollback decision:
   communicating with the server and processing the commit or rollback request, and upon successful processing,
   deleting a corresponding entry in the relational table, else
if the received request is a recover decision:
   querying the relational table to identify a list of indoubt units of work;
   transmitting the list of indoubt units of work to the client;
   receiving a commit or rollback decision from the client;
   communicating with the server to process the commit or rollback request, and upon successful processing, and
   deleting a corresponding entry in the relational table.

### CONCLUSION

A system and method has been shown in the above embodiments for the effective implementation of a system and method for supporting XA 2-phase commit protocols with a loosely coupled clustered database server. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific computing hardware.

The above enhancements are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in the art of database programming.

1. A method implementing a robust 2-phase commit protocol between a client and a server via a relational table and software facilitating communications with said client and said server, said relational table storing a list of potentially indoubt units of work, said method as implemented in said software comprising the steps of:
(a) receiving an invocation from said client for a first phase of commit for a transaction representing a unit of work;
(b) inserting an entry in said relational table corresponding to said unit of work and transmitting an instruction to said server to prepare to commit for said transaction, said inserted entry indicating said unit of work is potentially an indoubt entry; and
(c) receiving a request from said client to perform any of the following decisions: a COMMIT, a ROLLBACK, or a RECOVER, wherein said relational table is updated after execution of said request.

2. A method as per claim 1, wherein, if said received request is a COMMIT or a ROLLBACK decision, said method comprising the steps of:
communicating with said server and processing said COMMIT or ROLLBACK request, and upon successful processing,
deleting a corresponding entry in said relational table.

3. A method as per claim 1, wherein, if said received request is a RECOVER decision, said method comprising the steps of:
querying said relational table to identify a list of indoubt units of work;
transmitting said list of indoubt units of work to said client;
receiving a COMMIT or ROLLBACK decision from said client;
communicating with said server to process said commit or rollback request, and upon successful processing,
deleting a corresponding entry in said relational table.

4. A method as claim 1, wherein said server is a database cluster and said software supports execution of said recover decision even if one or more members of the database cluster are unavailable.

5. A method as per claim 1, wherein said relational table specifies row-level locking for keeping contention on said relation table to a minimum.

6. A method as per claim 1, wherein said relational table is a SQL table and said step of inserting an entry in said relational table is performed via issuing a SQL INSERT instruction.

7. A method as per claim 1, wherein said relational table is stored in said server and a request for said insertion of entry in said relational table is placed on a network message that includes said instruction to said server to prepare to commit for said transaction.

8. A method as per claim 1, wherein said method is implemented across networks.

9. A method as per claim 8, wherein said across networks element comprises any of, or a combination of, the following: local area network (LAN), wide area network, wireless network, or the Internet.

10. A method as per claim 1, wherein requests for deletions of entries in said relational table are placed on a separate network connection to avoid starting a new unit of work.

11. A method as per claim 1, wherein said method comprises the step of mapping said 2-phase protocol onto a protocol supported by said server.

12. An article of manufacture comprising computer usable medium having computer readable program code embodied therein implementing a robust 2-phase commit protocol between a client and a server via a relational table and software facilitating communications with said client and said server, said relational table storing a list of potentially indoubt units of work, said medium comprising:
(a) computer readable program code receiving an invocation from said client for a first phase of commit for a transaction representing an unit of work;
(b) computer readable program code inserting an entry in said relational table corresponding to said unit of work and transmitting an instruction to said server to prepare to commit for said transaction, said inserted entry indicating said unit of work is potentially an indoubt entry; and
(c) computer readable program code aiding in receiving a request from said client to perform any of the following decisions: a COMMIT, a ROLLBACK, or a RECOVER, wherein said relational table is updated after execution of said request.

13. An article of manufacture as per claim 12, said medium further comprising:
computer readable program code aiding in communicating with said server and processing said COMMIT or ROLLBACK request, and upon successful processing,
computer readable program code deleting a corresponding entry in said relational table.

14. An article of manufacture as per claim 12, said medium further comprising:
computer readable program code querying said relational table to identify a list of indoubt units of work;
computer readable program code aiding in transmitting said list of indoubt units of work to said client;
computer readable program code aiding in receiving a COMMIT or ROLLBACK decision;
computer readable program code aiding in communicating with said server to process said COMMIT or ROLLBACK request, and upon successful processing, and
computer readable program code deleting a corresponding entry in said relational table.

15. An article of manufacture as per claim 12, wherein said relational table specifies row-level locking for keeping contention on said relation table to a minimum.

16. An article of manufacture as per claim 12, wherein said relational table is a SQL table and computer readable program code inserts an entry in said relational table is performed via issuing a SQL INSERT instruction.

17. An article of manufacture as per claim 12, wherein said relational table is stored in said server and a request for said insertion of entry in said relational table is placed on a network message that includes said instruction to said server to prepare to commit for said transaction.

18. A method implementing a robust 2-phase commit protocol between a transaction manager and a database cluster via software facilitating communications with said transaction manager and said database cluster, said method as implemented in said software comprising the steps of:
(a) creating an SQL table for storing a list of potentially indoubt units of work
(b) receiving an invocation from said transaction manager for a first phase of commit for a transaction representing an unit of work;
(b) inserting, via an SQL INSERT instruction, an indoubt entry in said SQL table corresponding to said unit of work and transmitting an prepare to commit instruction to said database cluster, said SQL INSERT instruction and said prepare to commit instruction placed on one network message to minimize cost; and
(c) receiving a request from said transaction manager to perform any of the following decisions: a COMMIT, a ROLLBACK, or a RECOVER, wherein said SQL table is updated after execution of said request.

19. A method as per claim 18, wherein if said received request is a COMMIT or ROLLBACK decision, said method comprising the additional steps of:
communicating with said database cluster and processing said COMMIT or ROLLBACK request, and upon successful processing,
deleting a corresponding entry in said relational table via an SQL DELETE instruction.

20. A method as per claim 19, wherein said SQL DELETE instructions are paced on a separate network connection to avoid starting a new unit of work.

21. A method as per claim 18, wherein if said received request is a RECOVER decision, said method comprising the additional steps of:
querying said SQL table to identify a list of indoubt units of work;
transmitting said list of indoubt units of work to said transaction manager;
receiving a commit or rollback decision from said transaction manager;
communicating with said database cluster to process said commit or rollback request, and upon successful processing, and
deleting a corresponding entry in said SQL table via a SQL DELETE instruction.

22. A method as per claim 21, wherein said SQL DELETE instructions are paced on a separate network connection to avoid starting a new unit of work.

23. A method as per claim 18, wherein said SQL table specifies row-level locking for keeping contention on said relation table to a minimum.

24. A method as per claim 18, wherein said method is implemented across networks.

25. A method as per claim 24, wherein said across networks element comprises any of, or a combination of, the following: local area network (LAN), wide area network, wireless network, or the Internet.

26. Software implementing a 2-phase commit protocol between a client and a server comprising:
a first module invoked to create a relational table in said server to store potential indoubt units of work;
a second module invoked to insert or delete indoubt entries of work in said relational table,
wherein insertions of indoubt entries are performed if an invocation is received from said client for a first phase of commit for a transaction representing a unit of work; and
wherein deletions of indoubt entries are performed upon successful processing of a commit or rollback decision; and
a third module invoked upon receiving a recover instruction from said client, said third module extracting a list of indoubt units of work from said relational table and transmitting said extracted list to said client, wherein said client inspects said list and issues a commit or rollback decision to said middlware regarding said indoubt units of work in said list.

27. Software as claim 26, wherein said server is a database cluster and said software supports execution of said recover decision even if one or more members of the database cluster are unavailable.

28. Software as per claim 26, wherein said relational table specifies row-level locking for keeping contention on said relation table to a minimum.

29. Software as per claim 26, wherein said relational table is a SQL table and said step of inserting an entry in said relational table is performed via issuing a SQL INSERT instruction.

30. Software as per claim 26, wherein a request for said insertion of entry in said relational table is placed on a network message that includes an instruction to said server to prepare to commit for said transaction.

31. Software as per claim 26, wherein said software further comprises a fourth module mapping said 2-phase protocol onto a protocol supported by said server.
